(19) United States
(12) Patent Application Publication
(10) Pub. No.: US 2026/0211837 A1
(43) Pub. Date: Jul. 23, 2026

(54) METHOD AND APPARATUS FOR REMOTELY CONTROLLING PERIPHERAL COMPONENT INTERCONNECT EXPRESS (PCIE) DEVICE, ELECTRONIC DEVICE, AND MEDIUM

(71) Applicants: ZHEJIANG LAB, Hangzhou (CN); SHANGHAI ARTIFICIAL INTELLIGENCE INNOVATION CENTER, Shanghai (CN)

(72) Inventors: Hongcai CHENG, Hangzhou (CN); Kang FAN, Hangzhou (CN); Chao ZHOU, Hangzhou (CN); Hui XUE, Hangzhou (CN)

(73) Assignees: ZHEJIANG LAB, Hangzhou (CN); SHANGHAI ARTIFICIAL INTELLIGENCE INNOVATION CENTER, Shanghai (CN)

(21) Appl. No.: 19/358,471

(22) Filed: Oct. 15, 2025

(30) Foreign Application Priority Data
Jan. 23, 2025 (CN) 202510107481.4

(51) Int. Cl. G06F 13/42; H04L 67/1097

(52) U.S. Cl. CPC G06F 13/4282; H04L 67/1097; G06F 2213/0026

(57) ABSTRACT

An apparatus for remotely controlling a Peripheral Component Interconnect Express (PCIe) device includes: a local server and a remote server, where the local server is provided with a PCIe hardware device control component, a virtual PCIe bus, and a plurality of local Remote Direct Memory Access (RDMA) network interface cards; the remote server is provided with a PCIe hardware device, a PCIe hardware device agent component, and a plurality of remote RDMA network interface cards; the PCIe hardware device control component is configured to present the PCIe hardware device deployed on the remote server as a virtual PCIe device on a local central processing unit (CPU); the virtual PCIe bus is configured to manage the virtual PCIe bus and the virtual PCIe device on the bus for the local CPU; and the PCIe hardware device agent component is paired one-to-one with the PCIe hardware device deployed on the remote server.

### CROSS REFERENCE TO THE RELATED APPLICATIONS

This application is based upon and claims priority to Chinese Patent Application No. 202510107481.4, filed on Jan. 23, 2025, the entire contents of which are incorporated herein by reference.

### TECHNICAL FIELD

The present disclosure relates to the technical field of Peripheral Component Interconnect Express (PCIe) buses and devices, and in particular, to a method and apparatus for remotely controlling a PCIe device, an electronic device, and a medium.

### BACKGROUND

With the rapid development of information technologies, performance requirements for a computer system are constantly increasing. As a current mainstream high-speed serial computer expansion bus standard, Peripheral Component Interconnect Express (PCIe) has been widely applied in various computer systems. Due to its high speed, high bandwidth, and low latency, the PCIe has become a preferred interface for connecting various high-performance peripherals (such as a graphics processing unit, a network interface card, and a storage device). However, with a complex system architecture and diverse application scenarios, a PCIe device has a limited physical distance, which becomes a significant bottleneck for application expansion of the PCIe device.

Conventionally, a PCIe bus is designed based on a point-to-point connection, requiring a device and a host to communicate with each other within a limited physical distance, which is typically within a server device. As a result, in some scenarios, especially in application domains such as a data center, remote computing, and industrial automation, it is impossible to deploy the PCIe device in a remote or scattered location or flexibly deploy and use a required PCIe device. In this case, an extension technology has emerged to address the limited physical distance, such that the PCIe device can be remotely connected and controlled.

At present, a variety of PCIe extension technologies have been proposed. For example, requests of middleware software between a user end and a true PCIe device end are forwarded and synchronized by using a Remote Direct Memory Access (RDMA) network, or the PCIe device is extended and dynamically allocated based on a PCIe network. In the request forwarding and synchronization solution based on the RDMA network, middleware is added at a user end of software to adapt to an application and forward a request, and matching middleware is added at the true PCIe device end to receive the request and call a true driver program of the PCIe device to deliver the request to the PCIe device and return data returned by the physical PCIe device. In the PCIe device extension and allocation solution based on the PCIe network, a PCIe device of PCIe bridge type is added at both the user end of the software and the true PCIe device end to forward a PCIe request.

However, existing PCIe extension technologies have many shortcomings and challenges. For a software-based request forwarding solution, the middleware needs to perform interception, obtaining, and forwarding of a high-level device request. As a result, application software can only perform high-level requesting and usage for the PCIe device and cannot directly perform an underlying operation. Moreover, the middleware needs to be upgraded simultaneously with version upgrading of a native software interface of the PCIe device. Additionally, a request processing flow requires a plurality of switching operations between a kernel mode and a user mode, which affects overall request response performance. For the PCIe device extension and allocation solution based on the PCIe network, an extension distance is constrained by a length of the PCIe bus, and a PCIe extension range is typically limited to a cabinet level. Moreover, a PCIe switching and expansion device usually offers limited interfaces. The solution generally imposes a significant limitation on a large-scale PCIe device extension and reuse scenario. Additionally, PCIe devices and components have relatively high prices, which also hinders construction of a large-scale extension cluster.

In summary, although the existing PCIe extension technologies have partially addressed the limited physical distance of the PCIe device, they still face a series of challenges such as a high cost, low performance, a high power consumption, and poor scalability.

### SUMMARY

With respect to the deficiencies of the prior art, the present disclosure provides a method and apparatus for remotely controlling a PCIe device, an electronic device, and a medium.

According to a first aspect, an embodiment of the present disclosure provides an apparatus for remotely controlling a PCIe device, where the apparatus includes: a local server and a remote server;
the local server is provided with a PCIe hardware device control component, a virtual PCIe bus, and a plurality of local RDMA network interface cards;
the remote server is provided with a PCIe hardware device, a PCIe hardware device agent component, and a plurality of remote RDMA network interface cards;
the PCIe hardware device control component is configured to present the PCIe hardware device deployed on the remote server as a virtual PCIe device on a local CPU, and the virtual PCIe bus is configured to manage the virtual PCIe bus and the virtual PCIe device on the bus for the local CPU; and
the PCIe hardware device agent component is paired one-to-one with the PCIe hardware device deployed on the remote server, and is configured to serve as an agent to forward a PCIe request between the remote RDMA network interface card and the PCIe hardware device.

According to a second aspect, an embodiment of the present disclosure provides a method for remotely controlling a PCIe device, where at an initialization stage, the method includes:
starting a local server, and pre-allocating an address space for each virtual PCIe device in a PCIe hardware device control component;
when the local server connects to a remote PCIe hardware device, determining a remote server that needs to provide the remote PCIe hardware device, determining the remote PCIe hardware device and a to-be-connected remote PCIe hardware device, and logically removing the to-be-connected remote PCIe hardware device from the remote server;
configuring a PCIe hardware device agent component corresponding to the remote PCIe hardware device, and setting a working mode of the PCIe hardware device agent component to a remote service mode;
allocating an address range of a PCIe Base Address Register (BAR) space in the PCIe hardware device control component for the virtual PCIe device;
obtaining a required PCIe BAR space corresponding to the remote PCIe hardware device; based on a start address of the PCIe BAR space of the virtual PCIe device in the PCIe hardware device control component, re-allocating an address of a PCIe BAR space corresponding to the remote PCIe hardware device, such that the address of the PCIe BAR space of the remote PCIe hardware device is the same as an address of the PCIe BAR space of the virtual PCIe device in the PCIe hardware device control component; and synchronizing the address of the PCIe BAR space of the remote PCIe hardware device to the PCIe hardware device agent component;
establishing virtual address structure for an address space related to a PCIe hardware device in the PCIe hardware device control component and the PCIe hardware device agent component;
exchanging address structure of the virtual PCIe device in the PCIe hardware device control component with address structure of the PCIe hardware device agent component, obtaining complete address structure, separately registering the complete address structure to a local RDMA network interface card and a remote RDMA network interface card, and establishing a connection between the local RDMA network interface card and the remote RDMA network interface card; and
configuring a virtual PCIe bus, and adding a sub-bus under a root virtual PCIe bus, where the sub-bus corresponds to the virtual PCIe device in the PCIe hardware device control component.

According to a third aspect, an embodiment of the present disclosure provides an electronic device, including a memory and a processor, where the memory is coupled with the processor, the memory is configured to store program data, and the processor is configured to execute the program data to implement the above method for remotely controlling a PCIe device.

According to a fourth aspect, an embodiment of the present disclosure provides a computer-readable storage medium, storing a computer program thereon, where the computer program is executed by a processor to implement the above method for remotely controlling a PCIe device.

Compared with the prior art, the present disclosure has the following beneficial effects:
The present disclosure provides a method and apparatus for remotely controlling a PCIe device. A PCIe message is analyzed and processed to remotely and virtually access and use the PCIe device. Through an RDMA network, an extension distance and a scale of the PCIe device are increased. The present disclosure can extend a connection distance of the PCIe device, enhance transmission efficiency, and achieve good compatibility and standardization, providing a more complete and efficient solution for various application scenarios.

### BRIEF DESCRIPTION OF THE DRAWINGS

In order to describe the technical solutions in the embodiments of the present disclosure more clearly, the accompanying drawings required to describe the embodiments are briefly described below. Apparently, the accompanying drawings described below are only some embodiments of the present disclosure. Those of ordinary skill in the art may further obtain other accompanying drawings based on these accompanying drawings without creative efforts.

FIG. 1 is a schematic diagram of remotely controlling a PCIe device according to an embodiment of the present disclosure;

FIG. 2 is a structural diagram of remotely controlling a PCIe device according to an embodiment of the present disclosure;

FIG. 3 is a schematic diagram illustrating composition of a field of a PCIe hardware device control component according to an embodiment of the present disclosure;

FIG. 4 is a schematic diagram illustrating composition of a field of a PCIe hardware device agent component according to an embodiment of the present disclosure; and

FIG. 5 is a schematic diagram of an electronic device according to an embodiment of the present disclosure.

### DETAILED DESCRIPTION OF THE EMBODIMENTS

The technical solutions in the embodiments of the present disclosure are clearly and completely described below with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

It should be noted that, if there is no conflict, the following embodiments and features in implementations may be mutually combined.

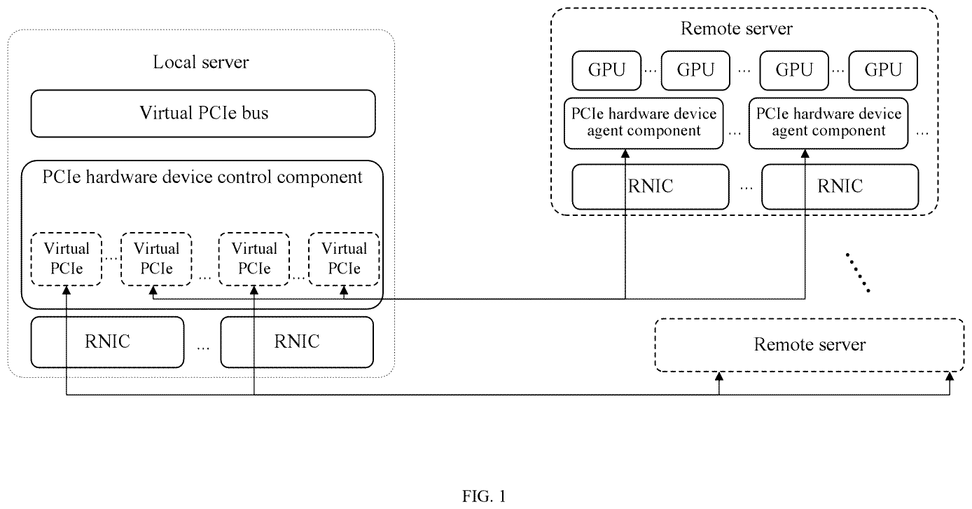

As shown in FIG. 1, an embodiment of the present disclosure provides an apparatus for remotely controlling a PCIe device. The apparatus includes: a local server and a remote server.

The local server is provided with a PCIe hardware device control component (device (DEV) Master), a virtual PCIe bus (Virt PCIe), a local PCIe device management module (DEV management Local), and a plurality of local RDMA network interface cards.

The remote server is provided with a PCIe hardware device (PCIe DEV), a PCIe hardware device agent component (DEV Agent), a remote PCIe device management module (DEV management Remote), and a plurality of remote RDMA network interface cards.

It should be noted that a plurality of PCIe DEVs deployed on one remote server can be mapped onto one local server to configure a virtual PCIe device; or a plurality of PCIe DEVs deployed on a plurality of remote servers can be mapped onto one local server to configure a virtual PCIe device; or a plurality of PCIe DEVs deployed on a plurality of remote servers can be mapped onto a plurality of local servers to configure a virtual PCIe device separately. In this embodiment, a quantity of local servers and a quantity of remote servers are not limited.

A remote PCIe DEV is presented as the virtual PCIe device on a local device CPU. Reading/writing performed by the local CPU for the virtual PCIe device is implemented as direct reading/writing for the PCIe hardware device control component (DEV Master). Reading/writing for an actual physical PCIe DEV is implemented through the local RDMA network interface card, the remote RDMA network interface card, and the PCIe hardware device agent component (DEV Agent).

For reading/writing performed by a remote physical PCIe DEV for a local CPU, memory, and device, a request is forwarded to the local server through the PCIe hardware device agent component (DEV Agent), the remote RDMA network interface card, and the local RDMA network interface card. Then, the reading/writing for the local CPU, memory, and device is implemented by the PCIe hardware device control component (DEV Master) or directly by the local RDMA network interface card.

Furthermore, the PCIe hardware device control component (DEV Master) is a hardware PCIe device, and configured to adapt to the local CPU. As a hardware device form, the PCIe hardware device control component (DEV Master) presents at least one PCIe DEV deployed on the remote server as the virtual PCIe DEV on the local CPU, enabling direct reading/writing between the local CPU and the remote PCIe DEV.

The PCIe hardware device control component (DEV Master) can virtually present a plurality of virtual PCIe devices on the local CPU, and each virtual PCIe device is associated with one remote PCIe hardware device agent component (DEV Agent). One DEV Master can correspond to a plurality of local RDMA network interface cards and a plurality of remote PCIe DEVs to mainly process a PCIe request (a configuration request and a reading/writing request) and control RDMA transmission. The PCIe hardware device control component (DEV Master) supports interaction with the local RDMA network interface card, and generates an RDMA reading/writing request or a local reading/writing request based on data reading/writing request information.

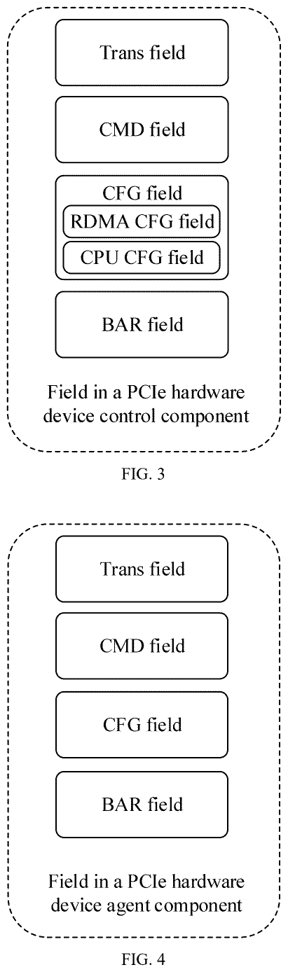

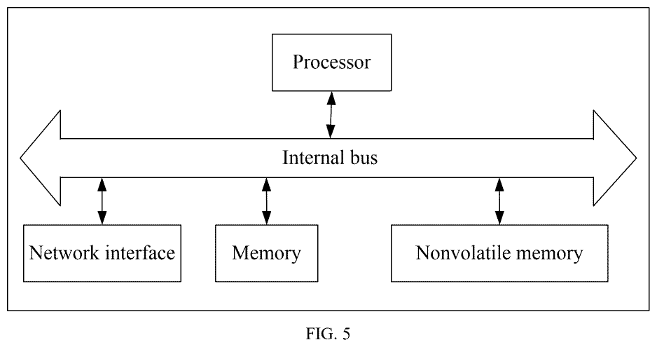

As shown in FIG. 3 and FIG. 4, each virtual PCIe device in the PCIe hardware device control component (DEV Master) and the PCIe hardware device agent component (DEV Agent) each contain four address ranges: a BAR field range, a configuration (CFG) field range, a command (CMD) field range for assisting in communication with the remote PCIe DEV, and a transmission (Trans) field range for assisting in data transmission with the remote PCIe DEV.

The BAR field of the virtual device in the PCIe hardware device control component (DEV Master) has a same size as that of the PCIe hardware device agent component (DEV Agent), and the BAR field of the virtual device in the PCIe hardware device control component (DEV Master) is accessed by the local CPU. A size of the CFG field of the virtual device in the PCIe hardware device control component (DEV Master) is twice that of the CFG field of the PCIe hardware device agent component (DEV Agent), and the CFG field of the PCIe hardware device control component (DEV Master) is divided into two equal fields that are respectively used for accessing the CPU and the local RDMA network interface card. The CMD field of the virtual device in the PCIe hardware device control component (DEV Master) has a same size as that of the PCIe hardware device agent component (DEV Agent). Addresses in the Trans field of the virtual device in the PCIe hardware device control component (DEV Master) and in the Trans field of the PCIe hardware device agent component (DEV Agent) are used to assist the data transmission, and a size of the Trans field of the virtual device in the PCIe hardware device control component (DEV Master) is not strongly correlated with a size of the Trans field of the PCIe hardware device agent component (DEV Agent).

It should be noted that there is a one-to-one association and mapping relationship between an address range in a BAR field and an actual PCIe BAR address range of the remote physical PCIe DEV. A PCIe configuration reading/writing operation performed by the local CPU for the remote physical PCIe DEV is completed by performing reading/writing on the above CFG field. A reading/writing operation performed for a BAR space of the remote physical PCIe DEV is completed by performing reading/writing on the above BAR field. Reading/writing performed by the DEV master for the CFG field and the BAR field of the remote PCIe DEV is realized by an RDMA network interface card by sending reading/writing requests for a CFG field and the BAR field to the DEV Agent. Reading/writing requests for the local CPU and another device space from the physical PCIe DEV are realized by the DEV Agent by interacting with the DEV Master through a CMD field and a Trans field of the DEV Agent.

During initialization, the PCIe hardware device control component (DEV Master) requests a sufficient large PCIe BAR space. Subsequently, when a new remote PCIe DEV is added for presentation, the DEV Master allocates a field in its own BAR space as a dedicated address range for the remote PCIe DEV. An address range of each remote PCIe DEV in the DEV Master includes a CFG field, a BAR field, a CMD field, and a Trans field. The DEV Master provides each remote physical PCIe DEV with an independent field, which is nested within a PCIe BAR address of the DEV Master, so as to respond to PCIe reading/writing request messages for the field from the CPU and the RDMA network interface card and perform processing.

Furthermore, a process in which the PCIe hardware device control component (DEV Master) interacts with the local RDMA network interface card and generates the RDMA reading/writing request or the local reading/writing request is as follows:

The DEV Master converts configuration reading/writing performed by the local CPU for the remote physical PCIe DEV and data reading/writing for the PCIe BAR space into an RDMA reading/writing request for the remote DEV Agent.

A reading/writing request for a local address space from the remote PCIe DEV is transmitted to the local DEV Master through the RDMA reading/writing request, and the DEV Master responds to the reading/writing request and configures software and hardware environments of the local server to assist in completing the reading/writing request.

A field corresponding to the Virt device in the DEV Master is the BAR field range, the CFG field range, the CMD field range for assisting in the communication with the remote PCIe DEV, and the Trans field range for assisting in the data transmission with the remote PCIe DEV, which has been pre-registered to the local RDMA network interface card.

The DEV Master has already established a connection to a corresponding remote RDMA network interface card in advance. The DEV Master interacts with the local RDMA network interface card to generate an RDMA request to submit a transmission task to the local RDMA network interface card. A specific method may include, but is not limited to, direct generation by the DEV Master and submission to the local RDMA network interface card, and submission to the local RDMA network interface card with the help of auxiliary software.

A process in which a configuration space reading/writing request of the CPU for the remote PCIe DEV is forwarded by the DEV Master includes:

For each Virt device, a CFG field is internally divided into two parts of a same size, which are respectively used for reading/writing interaction with the CPU and the local RDMA network interface card. There is a one-to-one mapping between the two parts, and data is forwarded between the two parts by the DEV Master.

When the CPU sends a reading/writing request to the part that is of the CFG field of the DEV Master and used for the CPU, the DEV Master stores the reading/writing request and data. Then, the local RDMA network interface card performs reading/writing on the address of the RDMA CFG field to transfer the data to a remote end.

When the CPU initiates a PCIe reading request for the CFG field of the DEV Master, after receiving data written by the local RDMA network interface card into the corresponding address of the CFG field, the DEV Master returns the data to the CPU in a form of a PCIe reading completion message. Once the CPU receives the PCIe reading completion message, configuration reading ends.

When the CPU initiates a PCIe writing request for the CFG field of the DEV Master, after a writing operation ends, software of the CPU waits for a signal that is from the DEV Master and indicates completion of configuration writing of the remote PCIe DEV. After receiving a signal that is from the RDMA network interface card and indicates completion of RDMA writing from the CFG field of the DEV Master to the CFG field of the remote DEV Agent, the DEV Master sends a signal indicating the completion of the configuration writing of the remote PCIe DEV to the CPU. A method used by the DEV Master to feed back the completion signal to the CPU includes but is not limited to setting a value of a write flag register, and sending an interrupt signal.

A process in which a BAR address space reading/writing request for the remote PCIe DEV from the CPU is forwarded by the DEV Master is as follows:

The direct address of a PCIe reading/writing request sent by the local CPU belongs to an independent address space of the BAR space of the DEV Master, to be specific to the BAR field in the DEV Master, which corresponds to the BAR address of remote physical PCIe DEV.

The DEV Master maps the local BAR space address in a reading/writing request of the CPU to the corresponding BAR field of the remote DEV Agent, and simultaneously allocates an address range that is in a Trans field of the DEV Master and used for current data transmission. Then, a BAR space address of the remote DEV Agent and a locally allocated Trans address are used as source and destination addresses for local RDMA transmission.

When the local RDMA network interface card sends a PCIe data reading/writing request to the Trans address, the DEV Master obtains data from a writing instruction of the CPU based on a mapping relationship established during the allocation of the Trans address and forwards the data to the local RDMA network interface card, or uses data of the writing request of the local RDMA network interface card to return a PCIe reading completion message in response to a reading instruction of the CPU.

A process in which the local DEV Master responds to the reading/writing request for the local address space from the remote PCIe DEV and completes necessary software and hardware configuration is as follows:

A data transmission mode used by the DEV Master to respond to a reading/writing request from the remote DEV Agent includes a mode in which the DEV Master reads/writes and forwards local data, and a mode in which the RDMA network interface card directly reads/writes the local data.

In the above forwarding mode implemented by the DEV Master, after receiving a reading/writing containing a final destination address from the DEV Agent, the DEV Master allocates a corresponding data reading/writing address range in the Trans field, and then notifies the DEV Agent to perform RDMA reading/writing on a Trans field allocated by the DEV Master. After receiving PCIe reading/writing for Trans field, the DEV Master converts the reading/writing into reading/writing for the final destination address in the local address space.

In the direct reading/writing mode implemented by the RDMA network interface card, when receiving the reading/writing request containing the final destination address from the DEV Agent, the DEV Master establishes a corresponding virtual address space page table for a final reading/writing address range, registers an address range with the RDMA network interface card, and then notifies the DEV Agent to directly perform the RDMA reading/writing on the final destination address.

The DEV Master performs configuration reading/writing for the physical PCIe DEV by performing reading/writing for the CFG field of the DEV Agent through the RDMA network interface card. A process is mainly as follows:

When the CPU sends a configuration reading/writing request to the DEV Agent through the DEV Master, the remote RDMA network interface card performs PCIe reading/writing for the CFG field of the DEV Agent. The DEV Agent then sends the reading/writing request to a physical DEV in a form of a PCIe configuration message and receives corresponding response information.

When the remote RDMA network interface card sends a PCIe writing request to a CFG field of the DEV Agent, the DEV Agent determines a CFG space address of a current writing operation for a PCIe DEV and content of written data based on information of the writing request, generates a PCIe configuration writing command that is for the PCIe DEV and contains a corresponding configuration address and the data, and sends the PCIe configuration writing command to the PCIe DEV. After receiving response information indicating completion of configuration writing from the PCIe DEV, the DEV Agent sends response information to the local DEV Master through the CMD space to notify the DEV Master that the writing request has been completed.

When the remote RDMA network interface card sends a PCIe reading request to the CFG field of the DEV Agent, the DEV Agent determines, based on information of the reading request, a CFG space address of a PCIe DEV that performs a current reading operation (the CFG space address can be determined through one-to-one mapping between written message received by the DEV Agent and a CFG address of the PCIe DEV, and a specific method includes but is not limited to one-to-one mapping of a CFG request address range of the DEV Agent and a CFG space of the PCIe DEV, and containing the CFG address of the PCIe DEV in written data), generates a PCIe configuration reading command that is for the PCIe DEV and contains a CFG space reading address, and sends the PCIe configuration reading command to the PCIe DEV. After receiving response information indicating completion of configuration reading from the PCIe DEV, the DEV Agent generates a PCIe response message of the reading request of the remote RDMA network interface card based on the response data of configuration read, and the RDMA network interface card transmits reading completion information to the local DEV Master.

The local DEV Master performs reading/writing for a BAR address space of the remote physical PCIe DEV by performing reading/writing for a BAR address space of the DEV Agent through the RDMA network interface card. A process is mainly as follows:

When the DEV Agent receives a PCIe reading/writing request for its BAR field from the RDMA network interface card, the DEV Agent determines, based on a requested address, a BAR address of a physical PCIe DEV that needs to be actually accessed, and sends a corresponding PCIe reading/writing request message to the PCIe DEV. For a reading request, after receiving a reading request response from the physical PCIe DEV, the DEV Agent returns a corresponding PCIe reading response message to the RDMA network interface card.

The reading/writing requests from the physical PCIe DEV to the local CPU and the another device space are forwarded by the DEV Master. A process is as follows:

The DEV Agent receives a PCIe reading/writing request for an address from the physical PCIe DEV, allocates an address range for current RDMA transmission in a Trans field of the DEV Agent, selects a current data transmission mode (the transmission mode is the forwarding implemented by the DEV Master or the direct reading/writing mode implemented by the RDMA network interface card), and then notifies the local DEV Master of a destination address, a data length, and a transmission type for the requested transmission. The DEV Master allocates a Trans field or establishes a virtual page table of a local physical address based on different transmission modes. Subsequently, data transmission between the remote DEV Agent and a local server is carried out through RDMA (an actual RDMA request initiating party is not restricted, and an RDMA non-initiating party needs to synchronize it's RDMA transmission address to the RDMA initiating party). When receiving a reading/writing request from the RDMA network interface card, the DEV Agent uses previously received written PCIe data sent by the physical PCIe DEV to respond to the reading request of the RDMA network interface card, or uses written data of the RDMA network interface card to respond to the reading request from the physical PCIe DEV.

Furthermore, the virtual PCIe bus (Virt PCIe) is a software module, and is configured to manage the virtual PCIe bus and the virtual PCIe DEV on the bus for the local CPU.

Specifically, a virtual bus of the virtual PCIe bus (Virt PCIe) includes a root bus and a plurality of sub-buses. The sub-bus is mounted to the root bus, and each virtual PCIe device is mounted to one sub-bus. There is a one-to-one correspondence between the sub-bus and the virtual PCIe device, and a quantity of sub-buses increases or decreases synchronously with addition or deletion of the virtual PCIe device. Configuration reading/writing for a device on the bus through the sub-bus is implemented as reading/writing for a CFG space address range of the virtual PCIe device in the PCIe hardware device control component (DEV Master).

Furthermore, the PCIe hardware device agent component (DEV Agent) is configured to adapt to the PCIe DEV deployed on the remote server. As a hardware device form, the PCIe hardware device agent component (DEV Agent) is logically presented as a single-port PCIe bridge, which is responsible for external adaptation and management of the remote PCIe DEV from a macro perspective. There is a one-to-one pairing relationship between the DEV Agent and the PCIe DEV. In terms of physical connection, the DEV agent is the only hardware device directly connected to the PCIe DEV, and mainly forwards a PCIe request (a configuration access request and a BAR space reading/writing request) between the remote RDMA network interface card and the PCIe DEV, and simultaneously achieves logical isolation of hardware of the PCIe DEV from other devices on the remote server.

Furthermore, the PCIe hardware device agent component (DEV Agent) has two main working modes: a transparent bridge mode and a remote service mode. In the remote service mode, all external requests from the PCIe DEV are processed by the DEV Agent as requests for the local server. A PCIe BAR address space of the DEV Agent contains a control field of the PCIe DEV, and the control field includes the CFG field, the BAR field, the CMD field, and the Trans field.

Specifically, the PCIe hardware device agent component (DEV Agent) is a PCIe NTB bridge in terms of a hardware structure, with one end connected to one remote PCIe DEV and the other end connected to a PCIe bus of the remote server. In terms of a logical function, the PCIe hardware device agent component forwards a PCIe reading/writing request between the remote PCIe DEV and the remote RDMA network interface card. In the PCIe bus of the remote server, an independent PCIe BAR address space is provided for a corresponding physical PCIe DEV, and external PCIe address reading/writing for the PCIe BAR address space is converted into reading/writing for the physical PCIe DEV. The PCIe hardware device agent component (DEV Agent) is presented as an ordinary endpoint (EP) device for the PCIe bus of the remote server, and as a quasi-Root Complex (RC) device (namely, a root concentrator) for the physical PCIe DEV.

The DEV Agent is presented as the quasi-RC device for the physical PCIe DEV, which can specifically support active initiation of a PCIe configuration reading/writing message for the physical PCIe DEV, and forwarding of PCIe interrupt and event messages to the local DEV Master.

Furthermore, both the local PCIe device management module (DEV management Local) and the remote PCIe device management module (DEV management Remote) are software modules. The local PCIe device management module is configured to manage the virtual PCIe device, configure and manage the PCIe hardware device control component (DEV Master) and the virtual PCIe bus (Virt PCIe), and assist in the RDMA transmission. The remote PCIe device management module (DEV management Remote) is configured to manage the PCIe DEV in a cluster, control remote usage and allocation of the PCIe DEV, configure and manage the PCIe hardware device agent component (DEV Agent), and assist in the RDMA transmission, such as generating a command of the RDMA network interface card, and managing a memory page table of a hardware address space.

Furthermore, both the local RDMA network interface card and the remote RDMA network interface card are standard RDMA network interface cards and necessary software, and support data transmission by means of RDMA.

It should be noted that a core idea of the present disclosure is to achieve remote direct hardware reading/writing through an RDMA network. A PCIe message processing device is separately set up at the local server and the remote end to perform direct access and data processing on the PCIe device inside a server, thereby connecting the RDMA network interface card and a PCIe terminal. The present disclosure introduces the PCIe hardware device agent component (DEV Agent), the PCIe hardware device control component (DEV Master), and the RDMA network interface card (RNIC), such that the PCIe DEV in a remote server device can be virtually presented in the local server flexibly. This enables software in the local server to continue reusing a driver and library software of a native PCIe device. In the solutions of the present disclosure, the local server can arbitrarily select a PCIe card from a remote server and map the PCIe card onto the local server as a virtual device. In addition, the local server can flexibly select, based on a hardware resource and a performance requirement of its own network interface card, a network interface card for synchronous data transmission. In the solutions of the present disclosure, the software in the local server can support memory access and reading/writing, and configuration space reading/writing for a remote PCIe device, can support reading/writing performed by the remote PCIe device for a memory of the local server, and interrupt sending, and can also support peer-to-peer (P2P) transmission between remote PCIe devices corresponding to two virtual PCIe devices.

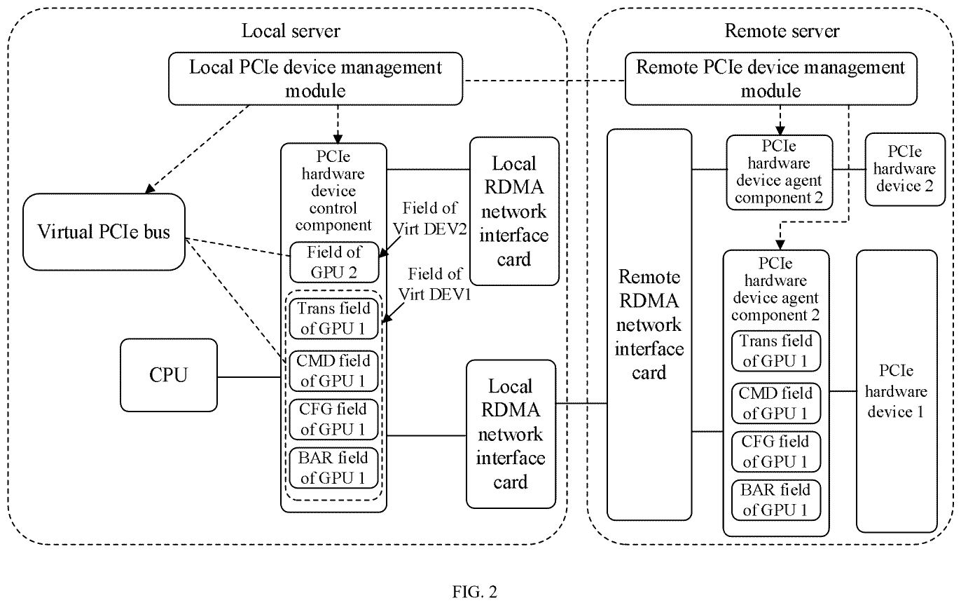

As shown in FIG. 2, in this embodiment, access to the PCIe device mainly involves memory reading/writing and configuration space reading/writing. In addition, GPU DMA, an MSI/MSI-X interrupt, and a P2P transmission characteristic are composed of configuration space and memory reading/writing processes at a hardware operation level. That is, support for typical configuration and memory access processes can enable typical functions and characteristics of the PCIe device to be used. The following separately describes processing flows under system initialization, PCIe configuration reading/writing, and ordinary memory reading/writing operations.

Furthermore, an embodiment of the present disclosure provides a method for remotely controlling a PCIe device. At an initialization stage, the method includes following steps:

Step S1: A local server is started, and an address space is pre-allocated for each virtual PCIe device in a PCIe hardware device control component (DEV Master).

Step S2: When the local server connects to a remote PCIe DEV, a remote server that needs to provide the remote PCIe DEV is determined. A remote PCIe hardware device management module (DEV management Remote) determines the remote PCIe DEV and a to-be-connected remote PCIe DEV, and logically removes the to-be-connected remote PCIe DEV from the remote server.

Step S3: The remote PCIe hardware device management module configures a PCIe hardware device agent component (DEV Agent) corresponding to the remote PCIe DEV, and sets a working mode of the PCIe hardware device agent component to a remote service mode.

Step S4: A local PCIe hardware device management module (DEV management Local) allocates an address range of a PCIe BAR space in the PCIe hardware device control component for the virtual PCIe device.

Step S5: The remote PCIe hardware device management module obtains a required PCIe BAR space corresponding to the remote PCIe DEV; based on a start address of the PCIe BAR space corresponding to the virtual PCIe device in the PCIe hardware device control component, re-allocates an address of a PCIe BAR space corresponding to the remote PCIe DEV, such that the address of the PCIe BAR space of the remote PCIe DEV is the same as an address of the PCIe BAR space corresponding to the virtual PCIe device in the PCIe hardware device control component; and synchronizes the address of the PCIe BAR space of the remote PCIe DEV to the PCIe hardware device agent component.

Step S6: Through the remote PCIe hardware device management module and the local PCIe hardware device management module, virtual address structure is established for an address space related to a PCIe DEV in the PCIe hardware device control component and the PCIe hardware device agent component.

Step S7: Address structure of the virtual PCIe device in the PCIe hardware device control component is exchanged with address structure of the PCIe hardware device agent component, complete address structure is obtained, the complete address structure is separately registered to a local RDMA network interface card and a remote RDMA network interface card, and a connection between the local RDMA network interface card and the remote RDMA network interface card is established.

Furthermore, the address structure of the virtual PCIe device includes a PCIe DEV BAR space, a DEV CFG space, a DEV CMD space, and a DEV Trans space. The address structure of the PCIe hardware device agent component includes its physical address and virtual address.

Step S8: The local PCIe hardware device management module configures a virtual PCIe bus (Virt PCIe), and adds a new sub-bus under a root virtual PCIe bus, where the sub-bus corresponds to the virtual PCIe device in the PCIe hardware device control component; sets a configuration access address for the virtual PCIe device under the sub-bus to the CFG space in an address of the virtual PCIe device; and adds the virtual PCIe device in the local PCIe hardware device management module.

Furthermore, an embodiment of the present disclosure provides a method for remotely controlling a PCIe device. At a configuration reading/writing stage, the method includes following steps:

Step S1: A configuration reading/writing interface of a virtual PCIe bus is called, and a configuration reading/writing request is sent to a corresponding address in a CFG space in which a virtual PCIe device in a PCIe hardware device control component is located, where the configuration reading/writing request includes a device number, a PCIe function number, an address of a configuration access register, and a reading/writing type; and a writing request further includes to-be-written data information.

Step S2: When receiving the configuration reading/writing request, the PCIe hardware device control component encapsulates the configuration reading/writing request into an RDMA data writing request, communicates with a remote RDMA network interface card through a local RDMA network interface card, sends the RDMA data writing request to a CFG field of a PCIe hardware device agent component, and sends an RDMA data reading request based on an address of result data in the CFG field of the PCIe hardware device agent component, where a destination address of the RDMA data reading request is a result data storage address in a CFG field of the PCIe hardware device control component.

Step S3: When receiving the configuration reading/writing request transmitted by the remote RDMA network interface card, the PCIe hardware device agent component generates a PCIe configuration reading/writing message based on the device number, the PCIe function number, destination register information, and the data information that is only for the writing request, sends the PCIe configuration reading/writing message to a PCIe DEV, and sets a bus number in the PCIe configuration reading/writing message to a bus number of a physical PCIe bus of the PCIe DEV.

Step S4: After receiving a configuration reading/writing completion response message returned by the PCIe DEV, the PCIe hardware device agent component places a configuration reading/writing result in a result data access address in a CFG field of the PCIe hardware device agent component, where in the case of a configuration reading request, it is also necessary to synchronously place a value of a configuration space register in the result data access address.

Step S5: When receiving a PCIe reading request for configuration result data from the remote RDMA network interface card, the PCIe hardware device agent component returns reading/writing result data to the remote RDMA network interface card in a form of a PCIe reading/writing response message; and when failing to receiving the PCIe reading request for the configuration result data from the remote RDMA network interface card, the PCIe hardware device agent component waits for the PCIe reading request, and then returns the configuration reading/writing result data to the remote RDMA network interface card.

Step S6: When receiving a PCIe data writing request sent by the local RDMA network interface card to the result data storage address in the CFG field of the PCIe hardware device control component, the PCIe hardware device control component calls the configuration reading/writing interface of the virtual PCIe bus, and after configuration reading/writing is completed, returns a configuration writing request or returns a configuration reading request with previously mentioned result data stored in the CFG field of the DEV Master.

Furthermore, an embodiment of the present disclosure provides a method for remotely controlling a PCIe device. At a memory reading/writing stage from a local server to a remote server, the method includes following steps:

Step S1: Because a PCIe BAR address of a virtual PCIe device belongs to a PCIe BAR field of a corresponding virtual PCIe device in a PCIe hardware device control component (DEV Master), when a local CPU performs memory reading/writing for the PCIe BAR address of the virtual PCIe device, a memory reading/writing request is sent to a PCIe BAR address of the corresponding virtual PCIe device in the PCIe hardware device control component.

Step S2: When receiving a PCIe memory reading/writing request for first address A (for a PCIe memory writing request, the PCIe hardware device control component needs to cache to-be-written data), the PCIe hardware device control component obtains, based on a mapping relationship that is between a local BAR address and a BAR address of a PCIe hardware device agent component and synchronously determined at an initialization stage, second address B that is used by the PCIe hardware device agent component to receive the memory reading/writing request and corresponds to the first address A.

An RDMA reading/writing request is submitted, and RDMA transmission is performed through a local RDMA network interface card and a remote RDMA network interface card. A type of the RDMA reading/writing request is consistent with a type of the memory reading/writing request received by the PCIe hardware device control component; and a source address and a destination address of the RDMA reading/writing request are respectively a local first address and a remote second address. It should be noted that since a mapping between a physical address and a virtual address has been established during initialization and is synchronized between the PCIe hardware device control component and the PCIe hardware device agent component, no distinction is made between the virtual address and the physical address herein.

Step S3A: When the local CPU sends a memory writing request, after the local server and the remote server initiate an RDMA request, the local RDMA network interface card sends a PCIe data reading request to the first address A in the PCIe hardware device control component. After receiving the PCIe data reading request sent by the local RDMA network interface card, the PCIe hardware device control component returns cached to-be-written data to the local RDMA network interface card as data in a PCIe reading completion message, and the local RDMA network interface card sends a writing request and the to-be-written data to the remote RDMA network interface card.

After receiving the writing request and the to-be-written data that are transmitted by the local RDMA network interface card, the remote RDMA network interface card sends a PCIe writing request to the second address B of the PCIe hardware device agent component. After receiving the PCIe writing request sent by the remote RDMA network interface card, the PCIe hardware device agent component caches the to-be-written data, calculates corresponding third address C in a PCIe DEV based on the second address B, and sends a PCIe writing request message to the PCIe DEV, where a destination address of the PCIe writing request message is the third address C, and data of the PCIe writing request message is the cached to-be-written data.

Step S3B: When the local CPU sends a memory reading request, after the local server and the remote server initiate an RDMA request, the local RDMA network interface card receives read data that is returned by the PCIe hardware device agent component and sent by the remote RDMA network interface card, and the local RDMA network interface card sends a PCIe data writing request to the first address A in the PCIe hardware device control component. After receiving the PCIe data writing request, the PCIe hardware device control component caches data of the writing request, and returns the data of the writing request to the local CPU as data in a completion message of a PCIe data reading request that is for the first address A from the local CPU. The local RDMA network interface card sends a reading request to the remote RDMA network interface card.

The remote RDMA network card receives the reading request transmitted by the local RDMA network interface card, and sends a PCIe reading request to the second address B of the PCIe hardware device agent component. After receiving the PCIe reading request sent by the remote RDMA network interface card, the PCIe hardware device agent component calculates corresponding third address C in a PCIe DEV based on the second address B, and sends a PCIe reading request message to the PCIe DEV. A destination address of the PCIe reading request message is the third address C. After receiving a PCIe reading response message returned by the PCIe DEV, the PCIe hardware device agent component extracts data in the PCIe reading response message, and returns the PCIe reading response message and the data in response to the reading request of the remote RDMA network interface card.

Furthermore, an embodiment of the present disclosure provides a method for remotely controlling a PCIe device. At a memory reading/writing stage from a remote server to a local server, the method includes following steps:

Step S1: A PCIe DEV sends a PCIe reading/writing request to a PCIe hardware device agent component; and the PCIe hardware device agent component receives a PCIe reading/writing request for first address A. For a writing request, the PCIe hardware device agent component needs to synchronously cache to-be-written data.

Step S2: The PCIe hardware device agent component determines a data transmission mode between the PCIe hardware device agent component and a PCIe hardware device control component based on an amount of to-be-read/written data: a forwarding mode implemented by the PCIe hardware device control component, and a direct transmission mode implemented by an RDMA network interface card.

Based on the amount of the to-be-read/written data, the PCIe hardware device agent component allocates a second address range B in a Trans field for current transmission.

Step S3: The PCIe hardware device agent component generates a data transmission request data frame, places the data transmission request data frame in a CMD field of the PCIe hardware device agent component, generates an RDMA transmission request by using an address in a CMD field of a corresponding virtual PCIe device in the PCIe hardware device control component as an address at another end, and transmits the generated data transmission request data frame to the PCIe hardware device control component.

The data transmission request data frame includes a to-be-read/written address, a type of a data reading/writing request, a length of read/written data, the selected data transmission mode, and the second address range.

Step S4: The PCIe hardware device control component receives the transmission request data frame written by a local RDMA network interface card into the CMD field of the virtual PCIe device in the PCIe hardware device control component. The PCIe hardware device control component parses the transmission request data frame, determines a local to-be-accessed destination address, namely the first address A, the type of the reading/writing request, the data length, the transmission mode, and the second address range B allocated by the PCIe hardware device control component.

Step S5: The PCIe hardware device control component determines a virtual third address required for RDMA transmission corresponding to the first address A. There are different methods for establishing the third address, depending on different transmission modes selected by the remote PCIe hardware device agent component.

In the forwarding mode implemented by the PCIe hardware device control component, the PCIe hardware device control component allocates physical fourth address D whose length is consistent with a length of to-be-transmitted data in a Trans field of the virtual PCIe device, and determines, based on a memory page table established for a field of the virtual PCIe device in an initialization process, a virtual address corresponding to the physical fourth address D, namely, the third address C.

In the direct transmission mode implemented by the RDMA network interface card, the PCIe hardware device control component creates a page table of a virtual address for the first address A, where a virtual address corresponding to the page table of the virtual address is the third address C, and registers a range of the third address C with the local RDMA network interface card.

Step S6: The PCIe hardware device control component constructs an RDMA request based on the second address B of the PCIe hardware device agent component, the third address C, and a reading/writing type, and submits the RDMA request to the local RDMA network interface card to trigger the RDMA network interface card to perform data transmission.

Step S7: When the remote PCIe hardware device agent component receives a PCIe reading/writing request for the second address B from a remote RDMA network interface card, corresponding processing is performed based on different reading/writing types.

When the remote RDMA network interface card initiates a reading request for the second address B, that is, when a physical PCIe device initiates a data writing request for the first address A, the remote PCIe hardware device agent component returns a PCIe reading response message to the RDMA network interface card, where data in the PCIe reading response message is previously cached to-be-written data of the physical PCIe device.

When the remote RDMA network interface card initiates a writing request for the second address B, that is, when the physical PCIe device initiates a data reading request for the first address A, the remote PCIe hardware device agent component receives PCIe writing message data of the remote RDMA network interface card, encapsulates the PCIe writing message data into a PCIe reading response message, and returns the PCIe reading response message to the physical PCIe device as a reading response message of the reading request for the first address A from the physical PCIe device.

In the forwarding mode implemented by the PCIe hardware device control component, the local RDMA network interface card sends the PCIe reading/writing request to the physical fourth address D of the PCIe hardware device control component, namely, the virtual third address C, and the PCIe hardware device control component receives a PCIe reading/writing request message. If the PCIe hardware device control component receives a PCIe writing request for a range of the fourth address D from the local RDMA network interface card, the PCIe hardware device control component caches to-be-written data, determines that final data is written into the first address A, encapsulates the cached data into a PCIe writing request message, and sends the PCIe writing request to the first address A.

If the PCIe hardware device control component receives a PCIe reading request for a range of the fourth address D from the local RDMA network interface card, the PCIe hardware device control component determines the first address A that needs to be finally read and accessed, sends a PCIe reading request message to the first address A, and after receiving a returned PCIe reading response message, extracts data in the PCIe reading response message, encapsulates the extracted data into a PCIe reading response message for the local RDMA network interface card, and sends the PCIe reading response message to the local RDMA network interface card.

In the direct transmission mode implemented by the RDMA network interface card, the local RDMA network interface card directly reads and writes local address A, namely the virtual third address C, and the PCIe hardware device control component does not need to intervene in a reading/writing process.

Step S8: At an end of the data transmission, the PCIe hardware device control component assists in resource recovery.

In the forwarding mode implemented by the PCIe hardware device control component, the PCIe hardware device control component reclaims the allocated range of the fourth address D.

In the direct transmission mode implemented by the RDMA network interface card, the PCIe hardware device control component cooperates with software to cancel a virtual page table mapping for the address A.

Step S9: After the remote PCIe hardware device agent component detects that reading/writing performed by the remote RDMA network interface card for the second address range B has completely covered a current data reading/writing range, it can be determined that current reading/writing has been completed. The remote PCIe hardware device agent component can reclaim the allocated second address range B.

### Embodiment 1

A main allocation process performed by a local server to add a virtual PCIe device is as follows:

Before allocation and usage, a remote PCIe device management module (DEV management Remote) detects and identifies a PCIe DEV in a remote server of the remote PCIe device management and an available PCIe DEV in an entire cluster.

When the local server needs to add a virtual PCIe device, the local server submits an application for a new PCIe device through a local PCIe device management module (DEV management Local). Based on a quantity and availability of PCIe DEVs on each remote server, scheduling and allocation are performed to determine a remote server that actually provides a physical PCIe DEV, and notify a remote PCIe device management module of the remote server. The remote PCIe device management module of the remote server allocates and determines a first PCIe hardware device (PCIe DEV1) that provides a service, as well as a corresponding RDMA network interface card. The remote PCIe device management module configures a remote PCIe hardware device agent component (DEV Agent) and the remote RDMA network interface card, and synchronizes relevant information to the local PCIe device management module (DEV management Local).

That the remote PCIe device management module configures the remote DEV Agent and the remote RDMA network interface card mainly includes: The remote DEV Agent is switched to a remote service mode. In the remote service mode, the DEV Agent enables a field that serves the remote PCIe DEV (including a BAR field, a CFG field, a CMD field, and a Trans field) in an address space of the DEV Agent and forwards messages sent by all remote PCIe DEVs to the local server. The DEV Agent reads a PCIe BAR space range of the remote PCIe DEV1, and allocates an address space that has a same size and quantity as a BAR range of the PCIe DEV1 in the BAR field of the DEV Agent. The remote PCIe device management module establishes a page table of a virtual address for an address range serving the PCIe DEV1 in the DEV Agent, and registers a virtual address range as a RDMA Memory Region to the remote RDMA network card. The remote PCIe device management module creates content required by the remote RDMA network interface card to establish a link, including an RDMA Queue Pair (QP), a Global Identifier (GID), and an rKey of an address range of the DEV Agent.

The local PCIe device management module receives an address range related to the PCIe DEV1 of the DEV Agent (the BAR field further includes detailed BAR space requirement information of the remote PCIe DEV1) and QP, GID, and rKey information related to link establishment of an RDMA network, which are synchronized by the remote PCIe device management module. Subsequently, a field required to virtually present the remote PCIe DEV1, namely, a space of Virt DEV1, is allocated in a local DEV Master, and an address of a corresponding field in the remote DEV Agent is recorded and associated. The local PCIe device management module establishes a page table of a virtual address for the space of the Virt DEV1 of the DEV Master, and registers a Memory Region with a memory of a local RDMA network interface card. The PCIe device management module allocates the local RDMA network interface card, creates content required by the local RDMA network interface card to establish a link, including an RDMA QP, a GID, and an rKey of an address range of the local Virt DEV1, and then synchronizes address structure of the space of the local Virt DEV1 and the relevant information of the local RDMA link establishment to the remote PCIe device management module. Subsequently, the PCIe device management module controls the local RDMA to attempt to establish a connection to the remote RDMA.

The remote PCIe device management module receives information of the space of the Virt DEV1 and the information of the local RDMA link establishment from the local DEV Master, updates a start BAR address of the remote PCIe DEV1 to a corresponding start physical address of a BAR field of the Virt DEV1 in the local DEV Master, establishes a corresponding association relationship between a field in the DEV Agent and a corresponding field in the DEV Master, and then attempts to establish a connection to the local RDMA network interface card.

The local RDMA network interface card and the remote RDMA network interface card complete the connection establishment.

The local PCIe device management module adds a new virtual PCIe sub-bus to a virtual PCIe bus (Virt PCIe), and triggers a local operating system to scan and load the Virt DEV1. Under the PCIe sub-bus, there is the Virt DEV1. A PCIe configuration access operation of the PCIe sub-bus is implemented by accessing the remote PCIe DEV1 through the local DEV Master. After the operating system scans and loads the Virt DEV1, a PCIe BAR space address established for the Virt DEV1 is an address in a BAR range in a field of the Virt DEV1 in the local DEV Master.

Embodiment 2

A PCIe configuration access process performed by a CPU on a remote PCIe DEV is as follows:

When software of the CPU needs to perform PCIe configuration access for a Virt PCIe DEV (namely, the remote PCIe DEV), the software of the CPU calls a PCIe configuration access interface of a virtual PCIe bus of the Virt PCIe DEV, and performs reading/writing at a corresponding address offset in a CPU CFG range of a CFG field in a DEV Master.

After receiving a PCIe reading/writing request for a CPU CFG region of a virtual device in the DEV Master from the CPU, the DEV Master uses a corresponding address in an RDMA CFG region as a local address for reading/writing for an RDMA network interface card. If the CPU sends a writing request, data to be written by the CPU is simultaneously mapped into the corresponding address in the RDMA CFG region. Subsequently, a local PCIe device management module is triggered to create an RDMA reading/writing request. A request type is the same as a type of a configuration reading/writing request of the CPU, a remote address is a corresponding address in a CFG field of a DEV Agent, and a length is a length of the configuration reading/writing request of the local CPU.

After receiving a PCIe reading/writing request for an address in a CFG field in a DEV region of the remote DEV Agent from a remote RDMA network interface card, the remote DEV Agent obtains, based on a reading/writing address mapping, an address at which device configuration access is required. Then, based on a reading/writing type, an address of a reading/writing configuration space, a read/written length, and to-be-written data that is only for a writing request, a PCIe configuration reading/writing request for a remote physical PCIe DEV is generated and sent to the PCIe DEV. After receiving configuration reading/writing response information returned by the PCIe DEV, a remote PCIe device management module performs processing based on the reading/writing type. For a reading request, data in a configuration reading response returned by the PCIe DEV is extracted and used as response data for a remote RDMA reading request to respond to the remote RDMA reading request. For the writing request, the remote PCIe device management module is triggered to create an RDMA request to perform configuration writing to return a response for configuration writing performed by the local DEV Master. In the created RDMA request, addresses at two ends are pre-agreed addresses in a CMD address region, and content includes status information of writing completion.

When receiving configuration reading data in an RDMA CFG region or receives writing response information in the CMD address region, the local DEV Master prepares to respond to the configuration reading/writing request from the CPU. For a configuration reading request from the CPU, a PCIe reading response message is returned to the CPU. For A configuration writing request from the CPU, configuration writing interface function software of the CPU is notified through an interrupt or by writing a flag bit, to complete configuration writing.

### Embodiment 3

When a CPU needs to perform reading/writing for a BAR address of a virtual device, since the BAR address of the virtual device is set to a BAR field range of the virtual device in a local DEV Master during device scanning, the CPU actually performs PCIe reading/writing for a BAR field of the virtual device in the local DEV Master directly.

When the DEV Master receives a PCIe reading/writing request for BAR address A of a virtual device region, for a writing request, to-be-written data is synchronously cached. In the virtual device region, field B that has a same size as a data request is allocated in a Trans section, and an association mapping is established between the field B and an address range of a current BAR reading/writing request (i.e., the address A). Then, software of a local PCIe device management module is triggered to create an RDMA request. In the RDMA request, addresses are address B allocated in a Trans region of the local DEV Master and address C corresponding to address A in a device BAR of a remote DEV Agent, a read/written length is a length of requested data, and a type is a reading/writing type of a request from the CPU.

When the DEV Master receives a reading/writing request for the address B from a local RDMA network interface card, for a writing request, data is cached and is used as response message data for a reading request that is for the address A and from the CPU, and a reading response for the address A is returned to the CPU. For a reading request, previously cached data that is written by the CPU into the address A is used as data of an RDMA reading response message, and a reading response is turned to the local RDMA network interface card.

When a reading/writing request for the address C from a remote RDMA network interface card is received in a BAR field range of a DEV of the remote DEV Agent, to-be-requested address D of a remote physical PCIe DEV is determined based on a mapping relationship configured during initialization, and the reading/writing request is sent to the address D of the PCIe DEV. For a reading request, a reading request response from the PCIe DEV is waiting for, and then data of the reading request response is used as data of an RDMA reading request response message, and a response is made to the RDMA reading request.

After returning the reading response message to the CPU or the local RDMA network interface card, the DEV Master reclaims the address range B that is allocated in the Trans region of the DEV Master to assist in data transmission.

### Embodiment 4

A memory reading/writing process performed by an integrated CPU on a remote PCIe DEV is as follows:

Since ordinary PCIe reading/writing messages can be transmitted asynchronously, a DEV Master can receive a plurality of reading or writing requests and then make a response asynchronously. The DEV Master can also perform fused processing on the reading or writing requests

After receiving a reading or writing request for an address in a BAR field of a virtual device from the CPU, the DEV Master caches the reading or writing request and waits for arrival of other subsequent reading or writing requests. The DEV Master processes the reading and writing requests separately, and classifies them based on a reading/writing type. Once scheduled time is exceeded or an amount of to-be-processed data reaches a predetermined value, the DEV Master uniformly allocates addresses in a local Trans field based on the received reading or writing requests, triggers software of a local PCIe device management module to create an RDMA request, and sends a coalescing data reading/writing request to a remote DEV Agent.

### Embodiment 5

A reading/writing process performed by a remote PCIe DEV for a local memory address is as follows:

When the remote PCIe DEV needs to perform reading/writing for local memory address A, the remote PCIe DEV sends a PCIe reading/writing request message to a remote DEV Agent. In the message, an address of a reading/writing request is the A. For a writing request, to-be-written data is also contained.

After receiving the reading/writing request for the address A, the DEV Agent allocates an address space whose size is consistent with a data amount of the reading/writing request in a Trans region of the DEV Agent, and an address is B. For the writing request, the to-be-written data is synchronously cached. Based on an amount of to-be-read/written data and a status of a to-be-processed task, a DEV Master selects a transmission mode to be used on a DEV Master side: a forwarding mode implemented by the DEV Master or a direct transmission mode implemented by an RDMA network interface card. In a predetermined address in a CMD field of a device in the DEV Agent, a command request data frame is created, including the requested address A, a data length, the transmission mode used by the DEV Master, and the transmission address B in the DEV Agent. Then, a DEV Mngt is triggered to generate an RDMA request, and a request data frame is transmitted to a predetermined address in a CMD field of a virtual device in the DEV Master.

After the request data frame sent by the DEV Agent is received in the CMD field of the virtual device in the DEV Master, corresponding processing is performed based on a transmission mode set by the DEV Agent.

When the forwarding mode implemented by the DEV Master is used, the DEV Master allocates address C in a Trans field of the corresponding virtual device as an RDMA transmission address, and triggers a local PCIe device management module to create an RDMA request.

When the direct transmission mode implemented by the RDMA network interface card is used, the DEV Master triggers the DEV Mngt to establish a page table of a virtual address for a range of the local address A, and creates an RDMA request based on the address A (namely, a corresponding virtual address).

If the forwarding mode implemented by the DEV Master is used, when receiving a PCIe reading/writing request message for the address C from a local RDMA network interface card, the DEV Master sends the PCIe reading/writing message to the address A. For a reading request, reading result data is synchronously returned to the local RDMA network interface card in a form of a PCIe response message. After transmission is completed, the address range C allocated in the Trans field is reclaimed. If the direct transmission mode implemented by the RDMA network interface card is used, the DEV Agent does not need to directly intervene in the data transmission. After the RDMA transmission is completed, software of a remote PCIe device management module releases the page table of the virtual memory for the range of the address A.

After receiving a reading/writing request for the address B from a remote RDMA network interface card, for a reading request, the DEV Agent uses to-be-written data previously sent by a remote physical PCIe DEV as a PCIe response message and returns the PCIe response message to the remote RDMA network interface card. For a writing request, to-be-written data in the request is returned to the remote physical PCIe DEV in a form of a reading response message.

The above mainly focuses on implementation of the allocation, configuration, and access processes of the virtual PCIe device. Through these access processes, a typical PCIe device can interact with application software in a common way, such that a physical PCIe device can be used in an extension manner. It should be noted that the processes and implementation objects in the above-mentioned implementation do not need to be exactly the same as those described above. For example, when a remote device performs memory reading/writing for a local device, a transmission mode can also be determined by the PCIe hardware device control component (DEV Master).

Correspondingly, the present disclosure further provides an electronic device, including at least one processor; and a memory configured to store at least one program. The at least one processor executes the at least one program to implement the above-mentioned method for remotely controlling a PCIe device. FIG. 5 shows a hardware structure of any device that has a data processing capability and in which a method for remotely controlling a PCIe device according to an embodiment of the present disclosure is loaded. In addition to a processor, a memory, and a network interface that are shown in FIG. 5, any device that has the data processing capability and in which the apparatus in the embodiments is located usually may further include other hardware based on an actual function of the any device that has the data processing capability, and details are not described herein again.

Correspondingly, the present disclosure further provides a computer-readable storage medium storing a computer instruction. The computer instruction is executed by a processor to implement the above method for remotely controlling a PCIe device. The computer-readable storage medium may be an internal storage unit of the device that has the data processing capability in any of the above-mentioned embodiments, such as a hard disk or an internal storage. The computer-readable storage medium may also be an external storage device, such as a plug-in hard disk, a Smart Media Card (SMC), a Secure Digital (SD) card, or a flash card provided on the device. Further, the computer-readable storage medium may also include both the internal storage unit of the any device that has the data processing capability and the external storage device. The computer-readable storage medium is configured to store the computer program and other programs and data that are required by the any device that has the data processing capability, and may further be configured to temporarily store data that is output or to be output.

It should also be noted that the term “comprise/include”, “contain”, or any other variant thereof is intended to encompass a non-exclusive inclusion, such that a process, method, product, or device that includes a series of elements includes not only those elements, but also other elements not explicitly listed, or elements that are inherent to such a process, method, product, or device. Without more restrictions, an element defined by the phrase “including a . . . ” does not exclude the presence of another same element in a process, method, product, or device that includes the element.

The above descriptions are merely embodiments of the present disclosure, and are not intended to limit the present disclosure. Various changes and modifications may be made to the present disclosure by those skilled in the art. Any modification, equivalent substitution, and improvement made within the spirit and principle of the present disclosure should fall within the protection scope of the claims of the present disclosure.

1. A method for remotely controlling a Peripheral Component Interconnect Express (PCIe) device, wherein at an initialization stage, the method comprises:
starting a local server, and pre-allocating an address space for each virtual PCIe device in a PCIe hardware device control component;
when the local server connects to a remote PCIe hardware device, determining a remote server that needs to provide the remote PCIe hardware device, determining the remote PCIe hardware device and a to-be-connected remote PCIe hardware device, and logically removing the to-be-connected remote PCIe hardware device from the remote server;
configuring a PCIe hardware device agent component corresponding to the remote PCIe hardware device, and setting a working mode of the PCIe hardware device agent component to a remote service mode;
allocating an address range of a PCIe Base Address Register (BAR) space in the PCIe hardware device control component for the virtual PCIe device;
obtaining a required PCIe BAR space corresponding to the remote PCIe hardware device; based on a start address of the PCIe BAR space of the virtual PCIe device in the PCIe hardware device control component, re-allocating an address of a PCIe BAR space corresponding to the remote PCIe hardware device, such that the address of the PCIe BAR space of the remote PCIe hardware device is the same as an address of the PCIe BAR space of the virtual PCIe device in the PCIe hardware device control component; and synchronizing the address of the PCIe BAR space of the remote PCIe hardware device to the PCIe hardware device agent component;
establishing a corresponding virtual address structure for an address space related to a PCIe hardware device in the PCIe hardware device control component and the PCIe hardware device agent component;
exchanging address structure of the virtual PCIe device in the PCIe hardware device control component with address structure of the PCIe hardware device agent component, obtaining complete address structure, separately registering the complete address structure to a local Remote Direct Memory Access (RDMA) network interface card and a remote RDMA network interface card, and establishing a connection between the local RDMA network interface card and the remote RDMA network interface card; and
configuring a virtual PCIe bus, and adding a sub-bus under a root virtual PCIe bus, wherein the sub-bus corresponds to the virtual PCIe device in the PCIe hardware device control component.

2. The method for remotely controlling the PCIe device according to claim 1, wherein at a PCIe configuration reading/writing stage, the method comprises following steps:
calling a configuration reading/writing interface of the virtual PCIe bus, and sending a configuration reading/writing request to a corresponding address in a configuration (CFG) space in which the virtual PCIe device in the PCIe hardware device control component is located;
when receiving the configuration reading/writing request, encapsulating, by the PCIe hardware device control component, the configuration reading/writing request into an RDMA data writing request, communicating with the remote RDMA network interface card through the local RDMA network interface card, sending the RDMA data writing request to a CFG field of the PCIe hardware device agent component, and sending an RDMA data reading request based on an address of result data in the CFG field of the PCIe hardware device agent component;
when receiving the configuration reading/writing request transmitted by the remote RDMA network interface card, generating, by the PCIe hardware device agent component, a PCIe configuration reading/writing message, sending the PCIe configuration reading/writing message to the PCIe hardware device, and setting a bus number in the PCIe configuration reading/writing message to a bus number of a physical PCIe bus of the PCIe hardware device;
after receiving a configuration reading/writing completion response message returned by the PCIe hardware device, placing, by the PCIe hardware device agent component, a configuration reading/writing result in a result data access address in a CFG field of the PCIe hardware device agent component;
when receiving a PCIe reading request for configuration result data from the remote RDMA network interface card, returning, by the PCIe hardware device agent component, reading/writing result data to the remote RDMA network interface card in a form of a PCIe reading/writing response message; and
when receiving a PCIe data writing request sent by the local RDMA network interface card to a result data storage address in the CFG field of the PCIe hardware device control component, calling, by the PCIe hardware device control component, the configuration reading/writing interface of the virtual PCIe bus, and after configuration reading/writing is completed, returning a configuration writing request or returning a configuration reading request with previously mentioned result data stored in the CFG field of the DEV Master.

3. The method for remotely controlling the PCIe device according to claim 2, wherein the reading/writing request comprises a device number, a PCIe function number, an address of a configuration access register, and a reading/writing type; and a writing request further comprises to-be-written data information.

4. The method for remotely controlling the PCIe device according to claim 1, wherein a destination address of an RDMA data reading request is a result data storage address in a CFG field of the PCIe hardware device control component.

5. The method for remotely controlling the PCIe device according to claim 1, wherein at a memory reading/writing stage from the local server to the remote server, the method comprises:
when a local central processing unit (CPU) performs memory reading/writing on a PCIe BAR address of the virtual PCIe device, sending a memory reading/writing request to the PCIe BAR address of the virtual PCIe device in the PCIe hardware device control component;
when receiving a PCIe memory reading/writing request for a first address, obtaining, by the PCIe hardware device control component based on a mapping relationship between a local BAR address and a BAR address of the PCIe hardware device agent component, a second address that is used by the PCIe hardware device agent component to receive the memory reading/writing request and corresponds to the first address;
submitting an RDMA reading/writing request, and performing RDMA transmission through the local RDMA network interface card and the remote RDMA network interface card, wherein a type of the RDMA reading/writing request is consistent with a type of the memory reading/writing request received by the PCIe hardware device control component; and a source address and a destination address of the RDMA reading/writing request are respectively a local first address and a remote second address;
when the local CPU sends a memory writing request, after the local server and the remote server initiate an RDMA request, sending, by the local RDMA network interface card, a PCIe data reading request to the first address in the PCIe hardware device control component; and after receiving the PCIe data reading request sent by the local RDMA network interface card, returning, by the PCIe hardware device control component, cached to-be-written data to the local RDMA network interface card as data in a PCIe reading completion message, and sending, by the local RDMA network interface card, a writing request and the to-be-written data to the remote RDMA network interface card; and
after receiving the writing request and the to-be-written data that are transmitted by the local RDMA network interface card, sending, by the remote RDMA network interface card, a PCIe writing request to the second address of the PCIe hardware device agent component; after receiving the PCIe writing request sent by the remote RDMA network interface card, caching, by the PCIe hardware device agent component, the to-be-written data, calculating a corresponding third address in the PCIe hardware device based on the second address, and sending a PCIe writing request message to the PCIe hardware device, wherein a destination address of the PCIe writing request message is the third address, and data of the PCIe writing request message is the cached to-be-written data;
or
when the local CPU sends a memory reading request, after the local server and the remote server initiate an RDMA request, receiving, by the local RDMA network interface card, read data that is returned by the PCIe hardware device agent component and sent by the remote RDMA network interface card; sending, by the local RDMA network interface card, a PCIe data writing request to the first address in the PCIe hardware device control component; after receiving the PCIe data writing request, caching, by the PCIe hardware device control component, data of the writing request, and returning the data of the writing request to the local CPU as data in a completion message of a PCIe data reading request that is sent by the local CPU to the first address; and sending, by the local RDMA network interface card, a reading request to the remote RDMA network interface card; and
receiving, by the remote RDMA network card, the reading request transmitted by the local RDMA network interface card, and sending a PCIe reading request to the second address of the PCIe hardware device agent component; after receiving the PCIe reading request sent by the remote RDMA network interface card, calculating, by the PCIe hardware device agent component, a corresponding third address in the PCIe hardware device based on the second address, and sending a PCIe reading request message to the PCIe hardware device, wherein a destination address of the PCIe reading request message is the third address; and after receiving a PCIe reading response message returned by the PCIe hardware device, extracting, by the PCIe hardware device agent component, data in the PCIe reading response message, and returning the PCIe reading response message and the data in response to the reading request of the remote RDMA network interface card.

6. The method for remotely controlling the PCIe device according to claim 1, wherein at a memory reading/writing stage from the remote server to the local server, the method comprises:
sending, by the PCIe hardware device, a PCIe reading/writing request to the PCIe hardware device agent component; and receiving, by the PCIe hardware device agent component, a PCIe reading/writing request for a first address;
determining, by the PCIe hardware device agent component based on an amount of to-be-read/written data, a data transmission mode between the PCIe hardware device agent component and the PCIe hardware device control component, and a second address range that is in a transmission (Trans) field and used for current transmission;
generating, by the PCIe hardware device agent component, a data transmission request data frame, placing the data transmission request data frame in a command (CMD) field of the PCIe hardware device agent component, generating an RDMA transmission request by using an address in a CMD field of the virtual PCIe device in the PCIe hardware device control component as an address at another end, and transmitting the generated data transmission request data frame to the PCIe hardware device control component, wherein
the data transmission request data frame comprises a to-be-read/written address, a type of a data reading/writing request, a length of read/written data, the selected data transmission mode, and the second address range;
receiving, by the PCIe hardware device control component, the transmission request data frame written by the local RDMA network interface card into the CMD field of the virtual PCIe device in the PCIe hardware device control component; and parsing, by the PCIe hardware device control component, the transmission request data frame, determining a local to-be-accessed destination address, namely the first address, the type of the reading/writing request, the data length, the transmission mode, and a second address allocated by the PCIe hardware device control component;
determining, by the PCIe hardware device control component, a virtual third address required for RDMA transmission corresponding to the first address;
constructing, by the PCIe hardware device control component, an RDMA request based on the second address of the PCIe hardware device agent component, the third address, and a reading/writing type, and submitting the RDMA request to the local RDMA network interface card to trigger the RDMA network interface card to perform data transmission;
when the remote PCIe hardware device agent component receives a PCIe reading/writing request for the second address from the remote RDMA network interface card, performing following operations:
when the remote RDMA network interface card initiates a reading request for the second address, that is, when a physical PCIe device initiates a data writing request for the first address, returning, by the remote PCIe hardware device agent component, a PCIe reading response message to the RDMA network interface card, wherein data in the reading response message is previously cached to-be-written data of the physical PCIe device;
when the remote RDMA network interface card initiates a writing request for the second address, that is, when the physical PCIe device initiates a data reading request for the first address, receiving, by the remote PCIe hardware device agent component, PCIe writing message data of the remote RDMA network interface card, encapsulating the data into a PCIe reading response message, and returning the PCIe reading response message to the physical PCIe device as a reading response message that is of a previous reading request for the first address from the physical PCIe device; and
completing current reading/writing after the remote PCIe hardware device agent component detects that reading/writing performed by the remote RDMA network interface card for the second address range has completely covered a current data reading/writing range.

7. The method for remotely controlling the PCIe device according to claim 6, wherein the data transmission mode comprises a forwarding mode implemented by the PCIe hardware device control component, and a direct transmission implemented by an RDMA network interface card, wherein
a process in which the PCIe hardware device control component determines the virtual third address required for the RDMA transmission corresponding to the first address comprises:
in the forwarding mode implemented by the PCIe hardware device control component, allocating, by the PCIe hardware device control component, a physical fourth address whose length is consistent with a length of to-be-transmitted data in a Trans data transmission field of the virtual PCIe device, and determining, based on a memory page table established for a field of the virtual PCIe device in an initialization process, a virtual address corresponding to the physical fourth address, namely, the third address; and
in the direct transmission mode implemented by the RDMA network interface card, creating, by the PCIe hardware device control component, a page table of a virtual address for the first address, wherein a virtual address corresponding to the page table of the virtual address is the third address, and registering a third address range with the local RDMA network interface card; and
a process in which the remote PCIe hardware device agent component receives the PCIe reading/writing request for the second address from the remote RDMA network interface card comprises:
in the forwarding mode implemented by the PCIe hardware device control component, sending, by the local RDMA network interface card, the PCIe reading/writing request to the physical fourth address of the PCIe hardware device control component, namely, the virtual third address, receiving, by the PCIe hardware device control component, a PCIe reading/writing request message, and if the PCIe hardware device control component receives a PCIe writing request for a fourth address range from the local RDMA network interface card, caching, by the PCIe hardware device control component, to-be-written data, determining that final data is written into the first address, encapsulating the cached data into a PCIe writing request message, and sending the PCIe writing request to the first address; or
if the PCIe hardware device control component receives a PCIe reading request for a fourth address range from the local RDMA network interface card, determining, by the PCIe hardware device control component, the first address that needs to be finally read and accessed, sending a PCIe reading request message to the first address, and after receiving a returned PCIe reading response message, extracting data in the response message, encapsulating the extracted data into a PCIe reading response message for the local RDMA network interface card, and sending the PCIe reading response message to the local RDMA network interface card; and
in the direct transmission mode implemented by the RDMA network interface card, directly reading and writing, by the local RDMA network interface card, a local address, namely the virtual third address, wherein the PCIe hardware device control component does not need to intervene in a reading/writing process.

8. An apparatus for remotely controlling a PCIe device, configured to implement the method for remotely controlling the PCIe device according to claim 1, wherein the apparatus comprises: a local server and a remote server;
the local server is provided with a PCIe hardware device control component, a virtual PCIe bus, and a plurality of local RDMA network interface cards;
the remote server is provided with a PCIe hardware device, a PCIe hardware device agent component, and a plurality of remote RDMA network interface cards;
the PCIe hardware device control component is configured to present the PCIe hardware device deployed on the remote server as a virtual PCIe device on a local CPU, and the virtual PCIe bus is configured to manage the virtual PCIe bus and the virtual PCIe device on the bus for the local CPU; and
the PCIe hardware device agent component is paired one-to-one with the PCIe hardware device deployed on the remote server, and is configured to serve as an agent to forward a PCIe request between the remote RDMA network interface card and the PCIe hardware device.

9. An electronic device, comprising a memory and a processor, wherein the memory is coupled with the processor, the memory is configured to store program data, and the processor is configured to execute the program data to implement the method for remotely controlling the PCIe device according to claim 1.

10. A computer-readable storage medium, storing a computer program thereon, wherein the computer program is executed by a processor to implement the method for remotely controlling the PCIe device according to claim 1.

11. The apparatus for remotely controlling the PCIe device according to claim 8, wherein at a PCIe configuration reading/writing stage, the method comprises following steps:
calling a configuration reading/writing interface of the virtual PCIe bus, and sending a configuration reading/writing request to a corresponding address in a configuration (CFG) space in which the virtual PCIe device in the PCIe hardware device control component is located;
when receiving the configuration reading/writing request, encapsulating, by the PCIe hardware device control component, the configuration reading/writing request into an RDMA data writing request, communicating with the remote RDMA network interface card through the local RDMA network interface card, sending the RDMA data writing request to a CFG field of the PCIe hardware device agent component, and sending an RDMA data reading request based on an address of result data in the CFG field of the PCIe hardware device agent component;
when receiving the configuration reading/writing request transmitted by the remote RDMA network interface card, generating, by the PCIe hardware device agent component, a PCIe configuration reading/writing message, sending the PCIe configuration reading/writing message to the PCIe hardware device, and setting a bus number in the PCIe configuration reading/writing message to a bus number of a physical PCIe bus of the PCIe hardware device;
after receiving a configuration reading/writing completion response message returned by the PCIe hardware device, placing, by the PCIe hardware device agent component, a configuration reading/writing result in a result data access address in a CFG field of the PCIe hardware device agent component;
when receiving a PCIe reading request for configuration result data from the remote RDMA network interface card, returning, by the PCIe hardware device agent component, reading/writing result data to the remote RDMA network interface card in a form of a PCIe reading/writing response message; and
when receiving a PCIe data writing request sent by the local RDMA network interface card to a result data storage address in the CFG field of the PCIe hardware device control component, calling, by the PCIe hardware device control component, the configuration reading/writing interface of the virtual PCIe bus, and after configuration reading/writing is completed, returning a configuration writing request or returning a configuration reading request with previously mentioned result data stored in the CFG field of the DEV Master.

12. The apparatus for remotely controlling the PCIe device according to claim 11, wherein the reading/writing request comprises a device number, a PCIe function number, an address of a configuration access register, and a reading/writing type; and a writing request further comprises to-be-written data information.

13. The apparatus for remotely controlling the PCIe device according to claim 8, wherein a destination address of an RDMA data reading request is a result data storage address in a CFG field of the PCIe hardware device control component.

14. The apparatus for remotely controlling the PCIe device according to claim 8, wherein at a memory reading/writing stage from the local server to the remote server, the method comprises:
when a local central processing unit (CPU) performs memory reading/writing on a PCIe BAR address of the virtual PCIe device, sending a memory reading/writing request to the PCIe BAR address of the virtual PCIe device in the PCIe hardware device control component;
when receiving a PCIe memory reading/writing request for a first address, obtaining, by the PCIe hardware device control component based on a mapping relationship between a local BAR address and a BAR address of the PCIe hardware device agent component, a second address that is used by the PCIe hardware device agent component to receive the memory reading/writing request and corresponds to the first address;
submitting an RDMA reading/writing request, and performing RDMA transmission through the local RDMA network interface card and the remote RDMA network interface card, wherein a type of the RDMA reading/writing request is consistent with a type of the memory reading/writing request received by the PCIe hardware device control component; and a source address and a destination address of the RDMA reading/writing request are respectively a local first address and a remote second address;
when the local CPU sends a memory writing request, after the local server and the remote server initiate an RDMA request, sending, by the local RDMA network interface card, a PCIe data reading request to the first address in the PCIe hardware device control component; and after receiving the PCIe data reading request sent by the local RDMA network interface card, returning, by the PCIe hardware device control component, cached to-be-written data to the local RDMA network interface card as data in a PCIe reading completion message, and sending, by the local RDMA network interface card, a writing request and the to-be-written data to the remote RDMA network interface card; and
after receiving the writing request and the to-be-written data that are transmitted by the local RDMA network interface card, sending, by the remote RDMA network interface card, a PCIe writing request to the second address of the PCIe hardware device agent component; after receiving the PCIe writing request sent by the remote RDMA network interface card, caching, by the PCIe hardware device agent component, the to-be-written data, calculating a corresponding third address in the PCIe hardware device based on the second address, and sending a PCIe writing request message to the PCIe hardware device, wherein a destination address of the PCIe writing request message is the third address, and data of the PCIe writing request message is the cached to-be-written data;
or
when the local CPU sends a memory reading request, after the local server and the remote server initiate an RDMA request, receiving, by the local RDMA network interface card, read data that is returned by the PCIe hardware device agent component and sent by the remote RDMA network interface card; sending, by the local RDMA network interface card, a PCIe data writing request to the first address in the PCIe hardware device control component; after receiving the PCIe data writing request, caching, by the PCIe hardware device control component, data of the writing request, and returning the data of the writing request to the local CPU as data in a completion message of a PCIe data reading request that is sent by the local CPU to the first address; and sending, by the local RDMA network interface card, a reading request to the remote RDMA network interface card; and
receiving, by the remote RDMA network card, the reading request transmitted by the local RDMA network interface card, and sending a PCIe reading request to the second address of the PCIe hardware device agent component; after receiving the PCIe reading request sent by the remote RDMA network interface card, calculating, by the PCIe hardware device agent component, a corresponding third address in the PCIe hardware device based on the second address, and sending a PCIe reading request message to the PCIe hardware device, wherein a destination address of the PCIe reading request message is the third address; and after receiving a PCIe reading response message returned by the PCIe hardware device, extracting, by the PCIe hardware device agent component, data in the PCIe reading response message, and returning the PCIe reading response message and the data in response to the reading request of the remote RDMA network interface card.

15. The apparatus for remotely controlling the PCIe device according to claim 8, wherein at a memory reading/writing stage from the remote server to the local server, the method comprises:
sending, by the PCIe hardware device, a PCIe reading/writing request to the PCIe hardware device agent component; and receiving, by the PCIe hardware device agent component, a PCIe reading/writing request for a first address;
determining, by the PCIe hardware device agent component based on an amount of to-be-read/written data, a data transmission mode between the PCIe hardware device agent component and the PCIe hardware device control component, and a second address range that is in a transmission (Trans) field and used for current transmission;
generating, by the PCIe hardware device agent component, a data transmission request data frame, placing the data transmission request data frame in a command (CMD) field of the PCIe hardware device agent component, generating an RDMA transmission request by using an address in a CMD field of the virtual PCIe device in the PCIe hardware device control component as an address at another end, and transmitting the generated data transmission request data frame to the PCIe hardware device control component, wherein
the data transmission request data frame comprises a to-be-read/written address, a type of a data reading/writing request, a length of read/written data, the selected data transmission mode, and the second address range;
receiving, by the PCIe hardware device control component, the transmission request data frame written by the local RDMA network interface card into the CMD field of the virtual PCIe device in the PCIe hardware device control component; and parsing, by the PCIe hardware device control component, the transmission request data frame, determining a local to-be-accessed destination address, namely the first address, the type of the reading/writing request, the data length, the transmission mode, and a second address allocated by the PCIe hardware device control component;
determining, by the PCIe hardware device control component, a virtual third address required for RDMA transmission corresponding to the first address;
constructing, by the PCIe hardware device control component, an RDMA request based on the second address of the PCIe hardware device agent component, the third address, and a reading/writing type, and submitting the RDMA request to the local RDMA network interface card to trigger the RDMA network interface card to perform data transmission;
when the remote PCIe hardware device agent component receives a PCIe reading/writing request for the second address from the remote RDMA network interface card, performing following operations:
when the remote RDMA network interface card initiates a reading request for the second address, that is, when a physical PCIe device initiates a data writing request for the first address, returning, by the remote PCIe hardware device agent component, a PCIe reading response message to the RDMA network interface card, wherein data in the reading response message is previously cached to-be-written data of the physical PCIe device;
when the remote RDMA network interface card initiates a writing request for the second address, that is, when the physical PCIe device initiates a data reading request for the first address, receiving, by the remote PCIe hardware device agent component, PCIe writing message data of the remote RDMA network interface card, encapsulating the data into a PCIe reading response message, and returning the PCIe reading response message to the physical PCIe device as a reading response message that is of a previous reading request for the first address from the physical PCIe device; and
completing current reading/writing after the remote PCIe hardware device agent component detects that reading/writing performed by the remote RDMA network interface card for the second address range has completely covered a current data reading/writing range.

16. The apparatus for remotely controlling the PCIe device according to claim 15, wherein the data transmission mode comprises a forwarding mode implemented by the PCIe hardware device control component, and a direct transmission implemented by an RDMA network interface card, wherein
a process in which the PCIe hardware device control component determines the virtual third address required for the RDMA transmission corresponding to the first address comprises:
in the forwarding mode implemented by the PCIe hardware device control component, allocating, by the PCIe hardware device control component, a physical fourth address whose length is consistent with a length of to-be-transmitted data in a Trans data transmission field of the virtual PCIe device, and determining, based on a memory page table established for a field of the virtual PCIe device in an initialization process, a virtual address corresponding to the physical fourth address, namely, the third address; and
in the direct transmission mode implemented by the RDMA network interface card, creating, by the PCIe hardware device control component, a page table of a virtual address for the first address, wherein a virtual address corresponding to the page table of the virtual address is the third address, and registering a third address range with the local RDMA network interface card; and
a process in which the remote PCIe hardware device agent component receives the PCIe reading/writing request for the second address from the remote RDMA network interface card comprises:
in the forwarding mode implemented by the PCIe hardware device control component, sending, by the local RDMA network interface card, the PCIe reading/writing request to the physical fourth address of the PCIe hardware device control component, namely, the virtual third address, receiving, by the PCIe hardware device control component, a PCIe reading/writing request message, and if the PCIe hardware device control component receives a PCIe writing request for a fourth address range from the local RDMA network interface card, caching, by the PCIe hardware device control component, to-be-written data, determining that final data is written into the first address, encapsulating the cached data into a PCIe writing request message, and sending the PCIe writing request to the first address; or
if the PCIe hardware device control component receives a PCIe reading request for a fourth address range from the local RDMA network interface card, determining, by the PCIe hardware device control component, the first address that needs to be finally read and accessed, sending a PCIe reading request message to the first address, and after receiving a returned PCIe reading response message, extracting data in the response message, encapsulating the extracted data into a PCIe reading response message for the local RDMA network interface card, and sending the PCIe reading response message to the local RDMA network interface card; and
in the direct transmission mode implemented by the RDMA network interface card, directly reading and writing, by the local RDMA network interface card, a local address, namely the virtual third address, wherein the PCIe hardware device control component does not need to intervene in a reading/writing process.

17. The electronic device according to claim 9, wherein at a PCIe configuration reading/writing stage, the method comprises following steps:
calling a configuration reading/writing interface of the virtual PCIe bus, and sending a configuration reading/writing request to a corresponding address in a configuration (CFG) space in which the virtual PCIe device in the PCIe hardware device control component is located;
when receiving the configuration reading/writing request, encapsulating, by the PCIe hardware device control component, the configuration reading/writing request into an RDMA data writing request, communicating with the remote RDMA network interface card through the local RDMA network interface card, sending the RDMA data writing request to a CFG field of the PCIe hardware device agent component, and sending an RDMA data reading request based on an address of result data in the CFG field of the PCIe hardware device agent component;
when receiving the configuration reading/writing request transmitted by the remote RDMA network interface card, generating, by the PCIe hardware device agent component, a PCIe configuration reading/writing message, sending the PCIe configuration reading/writing message to the PCIe hardware device, and setting a bus number in the PCIe configuration reading/writing message to a bus number of a physical PCIe bus of the PCIe hardware device;
after receiving a configuration reading/writing completion response message returned by the PCIe hardware device, placing, by the PCIe hardware device agent component, a configuration reading/writing result in a result data access address in a CFG field of the PCIe hardware device agent component;
when receiving a PCIe reading request for configuration result data from the remote RDMA network interface card, returning, by the PCIe hardware device agent component, reading/writing result data to the remote RDMA network interface card in a form of a PCIe reading/writing response message; and
when receiving a PCIe data writing request sent by the local RDMA network interface card to a result data storage address in the CFG field of the PCIe hardware device control component, calling, by the PCIe hardware device control component, the configuration reading/writing interface of the virtual PCIe bus, and after configuration reading/writing is completed, returning a configuration writing request or returning a configuration reading request with previously mentioned result data stored in the CFG field of the DEV Master.

18. The electronic device according to claim 17, wherein the reading/writing request comprises a device number, a PCIe function number, an address of a configuration access register, and a reading/writing type; and a writing request further comprises to-be-written data information.

19. The electronic device according to claim 9, wherein a destination address of an RDMA data reading request is a result data storage address in a CFG field of the PCIe hardware device control component.

20. The electronic device according to claim 9, wherein at a memory reading/writing stage from the local server to the remote server, the method comprises:
when a local central processing unit (CPU) performs memory reading/writing on a PCIe BAR address of the virtual PCIe device, sending a memory reading/writing request to the PCIe BAR address of the virtual PCIe device in the PCIe hardware device control component;
when receiving a PCIe memory reading/writing request for a first address, obtaining, by the PCIe hardware device control component based on a mapping relationship between a local BAR address and a BAR address of the PCIe hardware device agent component, a second address that is used by the PCIe hardware device agent component to receive the memory reading/writing request and corresponds to the first address;
submitting an RDMA reading/writing request, and performing RDMA transmission through the local RDMA network interface card and the remote RDMA network interface card, wherein a type of the RDMA reading/writing request is consistent with a type of the memory reading/writing request received by the PCIe hardware device control component; and a source address and a destination address of the RDMA reading/writing request are respectively a local first address and a remote second address;
when the local CPU sends a memory writing request, after the local server and the remote server initiate an RDMA request, sending, by the local RDMA network interface card, a PCIe data reading request to the first address in the PCIe hardware device control component; and after receiving the PCIe data reading request sent by the local RDMA network interface card, returning, by the PCIe hardware device control component, cached to-be-written data to the local RDMA network interface card as data in a PCIe reading completion message, and sending, by the local RDMA network interface card, a writing request and the to-be-written data to the remote RDMA network interface card; and
after receiving the writing request and the to-be-written data that are transmitted by the local RDMA network interface card, sending, by the remote RDMA network interface card, a PCIe writing request to the second address of the PCIe hardware device agent component; after receiving the PCIe writing request sent by the remote RDMA network interface card, caching, by the PCIe hardware device agent component, the to-be-written data, calculating a corresponding third address in the PCIe hardware device based on the second address, and sending a PCIe writing request message to the PCIe hardware device, wherein a destination address of the PCIe writing request message is the third address, and data of the PCIe writing request message is the cached to-be-written data;
or
when the local CPU sends a memory reading request, after the local server and the remote server initiate an RDMA request, receiving, by the local RDMA network interface card, read data that is returned by the PCIe hardware device agent component and sent by the remote RDMA network interface card; sending, by the local RDMA network interface card, a PCIe data writing request to the first address in the PCIe hardware device control component; after receiving the PCIe data writing request, caching, by the PCIe hardware device control component, data of the writing request, and returning the data of the writing request to the local CPU as data in a completion message of a PCIe data reading request that is sent by the local CPU to the first address; and sending, by the local RDMA network interface card, a reading request to the remote RDMA network interface card; and
receiving, by the remote RDMA network card, the reading request transmitted by the local RDMA network interface card, and sending a PCIe reading request to the second address of the PCIe hardware device agent component; after receiving the PCIe reading request sent by the remote RDMA network interface card, calculating, by the PCIe hardware device agent component, a corresponding third address in the PCIe hardware device based on the second address, and sending a PCIe reading request message to the PCIe hardware device, wherein a destination address of the PCIe reading request message is the third address; and after receiving a PCIe reading response message returned by the PCIe hardware device, extracting, by the PCIe hardware device agent component, data in the PCIe reading response message, and returning the PCIe reading response message and the data in response to the reading request of the remote RDMA network interface card.
